(19) United States
(12) Patent Application Publication
(10) Pub. No.: US 2003/0172260 A1
(43) Pub. Date: Sep. 11, 2003

(54) Method of embedding an OS startup in portable devices

(76) Inventor: Sin-Ru Huang, Taipei (TW)

Correspondence Address: RABIN & CHAMPAGNE, PC, 1101 14TH STREET, NW, SUITE 500, WASHINGTON, DC, 20005, US

(21) Appl. No.: 10/197,895

(22) Filed: Jul. 19, 2002

(30) Foreign Application Priority Data
Mar. 6, 2002 (TW) 91104163

(51) Int. Cl. G06F 15/177

(52) U.S. Cl. 713/1

(57) ABSTRACT

The present invention relates to a method of embedding an OS startup in portable devices. First, a system registry is read. The system registry contains the size of the OS, the setup date of the OS, the number of files therein, and the checksum. Then, system information is acquired from the OS, and the checksum is calculated. If the calculated checksum is equal to the checksum recorded in the system registry and the system information is identical to that which is recorded in the system registry, the system registry is loaded, and the OS is started based on the information contained within the system registry.

### BACKGROUND OF THE INVENTION

1. Field of the Invention

The present invention relates to a method of embedding an OS startup in portable devices, and more particularly to a method of embedding an OS startup that enables portable devices to avoid incorrect or unreliable system registry loading according to the characteristics of the OS.

2. Description of the Related Art

The reliable and stable operation of portable devices, such as PDAs (Personal Digital Assistants), is an important industry goal. The stability of any portable device depends largely on its embedded operating system (OS). The portable device is stable if the embedded OS runs smoothly.

The OS requires users to set the configurations of data used. Some examples are hardware device preferences, user preferences, network information, such as Internet Protocol (IP) address, Domain Name Server (DNS) and PROXY servers. Since the data is closely bound with the OS, the system will crash if a virus damages the data or the component used for storing the data experiences a failure.

FIG. 1 shows the operation of a conventional method to start up an OS. First, the OS initializes its configuration (step S10). Then, the checksum is calculated to check that the system registry is correct (step S12). If the checksum is correct, the registry is loaded (step S14). If the checksum is not correct, by virtue of the registry being incorrect, default data is loaded instead (step S16).

The conventional method always checks the checksum to avoid loading incorrect registry data. However, one OS may have several compatible versions. Checking the checksum may ensure the correctness of the registry, but reliability is not ensured. Thus, the registry of one OS version may cause a system crash for another OS version.

### SUMMARY OF THE INVENTION

It is therefore an object of the present invention to provide a method of embedding an OS startup in portable devices that enables portable devices to avoid loading incorrect or unreliable system registry data, based on the characteristics of the OS.

According to one embodiment of the invention, a system registry is first read. The system registry contains the size of the OS, the setup date of the OS, the number of files therein, and the checksum. Then, system information is acquired from the OS, and the checksum is calculated. System information may contain the size of the OS and the number of files therein. If the calculated checksum is equal to the checksum that is recorded in the system registry and the size of the OS and the number of files therein recorded in system information are identical to those which are recorded in the system registry, the system registry is loaded and the OS is started based on the information contained within the system registry.

Furthermore, a system registry recording method for operating systems embedded in portable devices is also provided. First, the checksum of the OS is calculated and system information is acquired from the OS. Then, the checksum and system information are stored into the system registry.

### BRIEF DESCRIPTION OF THE DRAWINGS

The aforementioned objects, features and advantages of this invention will become apparent by referring to the following detailed description of the preferred embodiment with reference to the accompanying drawings, wherein:

FIG. 1 is a flow chart illustrating the operation of a conventional method to start an OS;

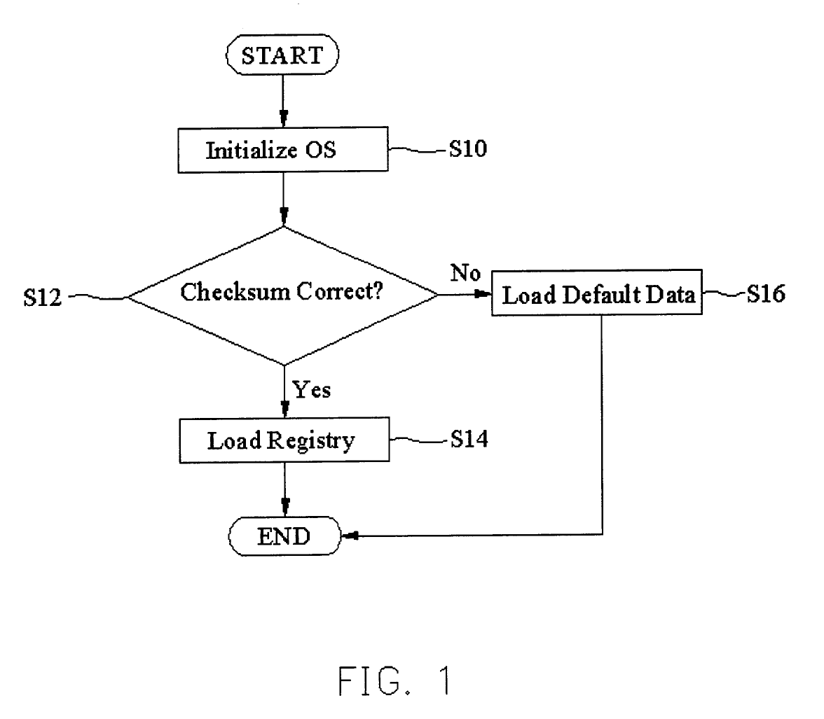

FIG. 2 is a flow chart illustrating the operation of the system registry recording method for operating systems embedded in portable devices according to the embodiment of the present invention; and

FIG. 3 is a flow chart illustrating the operation of the method of embedding an OS startup in portable devices.

### DETAILED DESCRIPTION OF THE INVENTION

As described above, the characteristics of the OS, such as the size of the OS, the setup date of the OS, and the number of files therein may be also used to verify the suitability of the system registry.

For purposes of description in this embodiment, the OS is the embedded OS in a PDA. The system registry stores the data concerning preference settings and the related information needed by the OS for its operation. If the system registry is destroyed, or the system registry is incorrect, the OS will encounter a system crash.

As an example, in an embedded OS, such as Windows CE Binary, “ROMHDR” stores system information, such as the size and number of files. Therefore, “ROMHDR” can be used to check the system registry. In order to save data length, the size and number of files recorded in “ROMHDR” are used to operate in coordination with the checksum of the OS for checking the system registry.

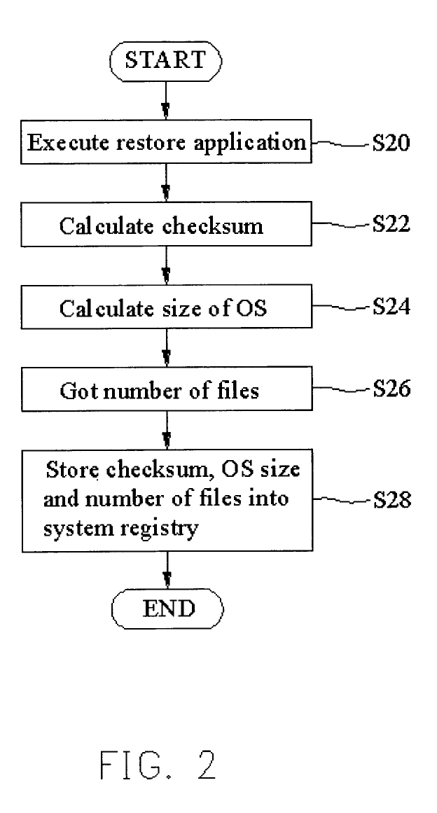

FIG. 2 shows the operation of the system registry recording method for operating systems embedded in portable devices according to the present invention. First, a registry restore application is executed or a RegFlushKey API is run to restore the system registry (step S20). Then, the checksum is calculated (step S22). Then, the system information size is calculated (ROMHDR.physlast-ROMHDR.physfirst) (step S24). Thereafter, the number of files (system information) is obtained (ROMHDR.numfiles) (step S26).

Finally, the checksum, the size of the OS, the number of files, and related information are stored into the system registry (step S28). It should be noted that the system information may also contain the setup date for the Windows CE Binary OS, and the date may also be stored into the system registry. The system registry may be stored in any storage unit used by portable devices.

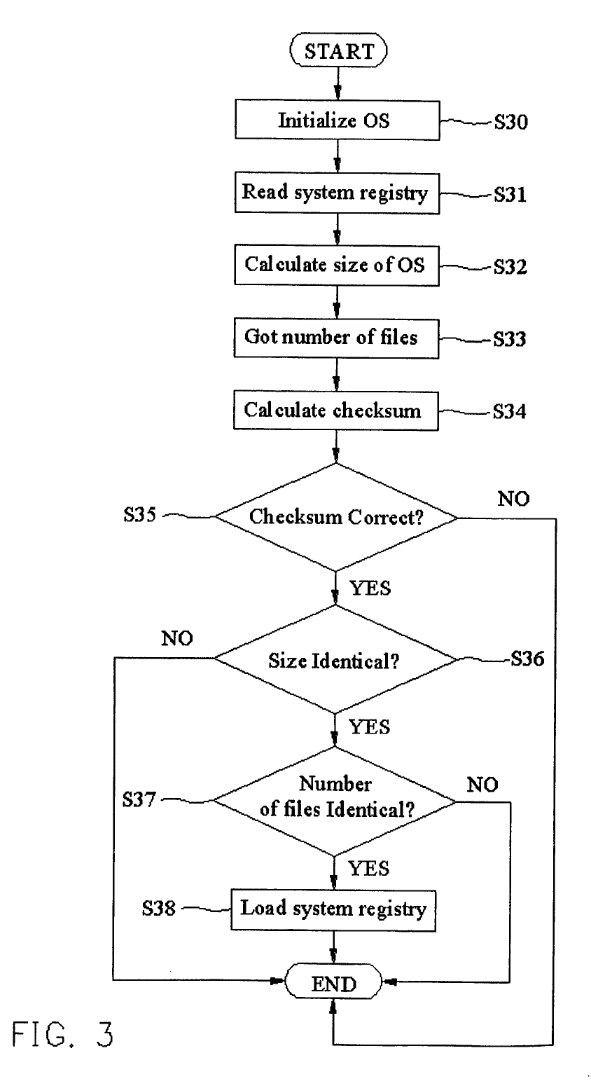

FIG. 3 shows the embedded OS startup method for portable devices. First, the OS is initialized (step S30). Then, the system registry is read (step S31). The system registry contains the size of the OS, the number of files, the checksum, and related preference settings data.

Then, the size of the OS is calculated (ROMHDR.physlast-ROMHDR.physfirst) and the number of files is retrieved (ROMHDR.numfiles) (steps S32 and S33). Note that in Windows CE Binary, the size of the OS and the number of files may be acquired in “ROMHDR”. Then, the checksum is calculated in step S34.

The calculated checksum is then compared to the checksum recorded in the system registry (step 35). If the calculated checksum is not equal to the checksum recorded in the system registry, the operation is terminated and the loading of the registry is halted.

If the calculated checksum is equal to the checksum recorded in the system registry, the calculated size is compared to that which is recorded in the system registry (step S36). If the calculated size is not identical to that which is recorded in the system registry, the operation is terminated and the loading of the registry is halted.

If the calculated size is identical to that which is recorded in the system registry, the calculated number of files is compared to that which is recorded in the system registry (step S37). If the calculated number of files is not identical to that which is recorded in the system registry, the operation is terminated and the loading of the registry is halted.

If the calculated number of files is identical to that which is recorded in the system registry, the system registry is loaded and Windows CE Binary is started, based on the information found within the system registry (step S38).

Furthermore, the system registry may also contain the setup date for Windows CE Binary. When the system registry is read in step S31, the date can be acquired and compared to the date that is to be loaded. If they are not identical, the operation is terminated. Otherwise, the system registry is loaded.

As a result, when using the system registry recording method and the embedded OS startup method in portable devices according to the present invention, the portable devices may avoid loading incorrect or unreliable system registry information according to the characteristics of the OS.

Although the present invention has been described in its preferred embodiment, it is not intended to limit the invention to the precise embodiment disclosed herein. Those who are skilled in the art can still make various alterations and modifications without departing from the scope and spirit of this invention. Therefore, the scope of the present invention shall be defined and protected by the following claims and their equivalents.

What is claimed is:

1. A method of embedding an OS startup in portable devices, comprising the steps of:
reading a system registry from the storage unit of the portable device;
acquiring system information from the OS;
calculating the checksum of the OS; and
loading the system registry and starting the OS based on the system registry if the calculated checksum is equal to the checksum that is recorded in the system registry and the system information is identical to that which is recorded in the system registry.

2. The method as claimed in claim 1 further initializing the OS.

3. The method as claimed in claim 1 wherein system information comprises the size of the OS.

4. The method as claimed in claim 1 wherein system information comprises the number of files in the OS.

5. The method as claimed in claim 1 wherein system information comprises the setup date of the OS.

6. The method as claimed in claim 1 wherein the portable device is a PDA.

7. The method as claimed in claim 1 wherein the OS is Windows CE.

8. The method as claimed in claim 1 wherein system information is recorded in binary code.

9. A system registry recording method for portable device embedded operating systems, comprising the steps of:
calculating the checksum of the OS;
acquiring system information from the OS; and
storing the calculated checksum and system information into the system registry.

10. The method as claimed in claim 9 wherein system information comprises the size of the OS.

11. The method as claimed in claim 9 wherein system information comprises the number of files contained within the OS.

12. The method as claimed in claim 9 wherein system information comprises the setup date of the OS.

13. The method as claimed in claim 9 wherein the portable device is a PDA.

14. The method as claimed in claim 9 wherein the OS is Windows CE.

15. The method as claimed in claim 9 wherein system information is recorded in binary code.
